(19) United States
(12) Patent Application Publication
(10) Pub. No.: US 2006/0068773 A1
(43) Pub. Date: Mar. 30, 2006

(54) Method and system for concurrent testing of multiple cellular phones

(76) Inventors: Mark A. Stambaugh, Post Falls, ID (US); Hung Fung Leung, Hong Kong (CN)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/951,645

(22) Filed: Sep. 28, 2004

(51) Int. Cl. H04Q 7/20

(52) U.S. Cl. 455/423

(57) ABSTRACT

Multiple cellular phones are connected to a test component by separate RF connections. The test component may be implemented within a test station or as a discrete test module. Each cell phone is assigned a unique channel or channels to communicate with the test component at or near the same time as the other cellular phones. The test component includes a channelized test circuit for testing the multiple cellular phones. Each cell phone may receive one or more signals from the test circuit or transmit a signal or signals to the test circuit using a respective assigned channel or channels. One or more compensation values may be used to compensate for losses incurred in each signal transmitted over the RF connections.

### BACKGROUND

In order to ensure mobile telephones are reliable and perform at a desired quality level, cell phone manufacturers perform various tests on their products. Typically a cell phone is connected to a test station for testing. The test station emulates a base station by generating and receiving the signals needed to establish and maintain a call on a traffic channel.

Some test stations allow a manufacturer to test two phones simultaneously by including two complete test circuits, such as transceivers, in one test station. This provides a high degree of isolation between the two phones during testing. Unfortunately, including two complete test circuits in a test station can increase the cost of the test station considerably.

Other test stations use a single test circuit and test one cell phone at a time. In order to increase or maximize the use of the test station, another cell phone can be inserted into a second test fixture while the first phone is tested. The second phone may then camp on the test station while the first cell phone is tested. But the second phone may not be able to camp reliably on the test station during test operations, or it may impose unacceptable constraints on how the first phone is tested. A radio frequency (RF) transmitter may be added to the test station to allow the second telephone to camp reliably while the first phone is tested, but this also increases the cost of the test station and does not allow the two phones to be tested concurrently.

### SUMMARY

In accordance with the invention, a method and system for concurrent testing of multiple cellular phones are provided. Multiple cellular phones are connected to a test component by separate RF connections. The test component may be implemented within a test station or as a discrete test module. Each cell phone is assigned a unique channel or channels to communicate with the test component at or near the same time as the other cellular phones. The test component includes a channelized test circuit for testing the multiple cellular phones. Each cell phone may receive one or more signals from the test circuit or transmit a signal or signals to the test circuit using a respective assigned channel or channels. One or more compensation values may be used to compensate for losses incurred in each signal transmitted over the RF connections.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a block diagram of a first testing system in an embodiment in accordance with the invention;

FIG. 2 is a block diagram of a second testing system in an embodiment in accordance with the invention;

FIG. 3 is a block diagram of cascading splitters in an embodiment in accordance with the invention; and

FIG. 4 is an illustration of a test component user interface in an embodiment in accordance with the invention.

### DETAILED DESCRIPTION

The following description is presented to enable one skilled in the art to make and use embodiments of the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

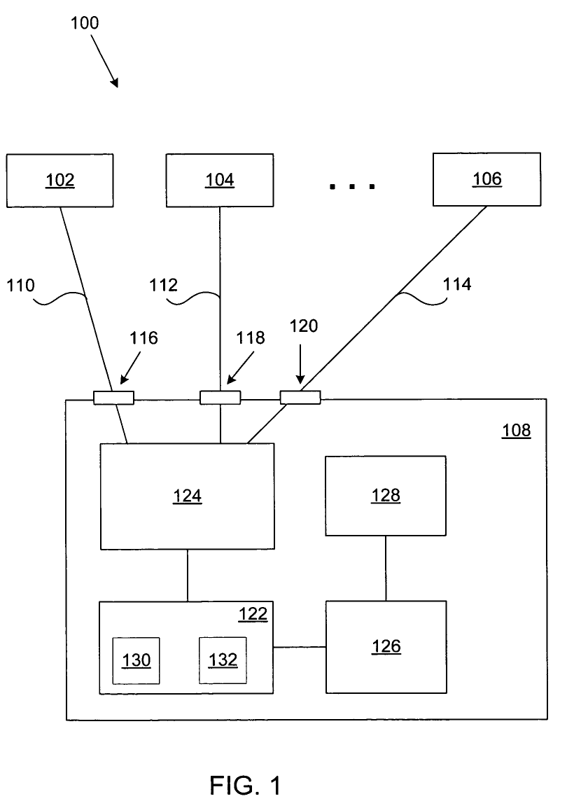

With reference to the figures and in particular with reference to FIG. 1, there is shown a block diagram of a first testing system in an embodiment in accordance with the invention. Testing system 100 includes cell phones 102, 104, 106 connected to test component 108 via cables 110, 112, and 114, respectively. Phones 102, 104, 106 are typically sitting in test fixtures (not shown) during test operations, and cables 110, 112, 114 connect the test fixtures to RF ports 116, 118, and 120, respectively.

Test component 108 includes channelized test circuit 122, splitter 124, controller 126, and memory 128. Test component 108 is implemented as a discrete test module in one embodiment in accordance with the invention. In another embodiment in accordance with the invention, test component 108 is implemented within a test station that includes one or more test components.

Test circuit 122 is any channelized circuit or device that may be used to test cellular phones 102, 104, 106. In the embodiment of FIG. 1, test circuit 122 includes a transceiver having both a transmitter 130 and receiver 132. Both the transmitter 130 and receiver 132 are used in testing cell phones 102, 104, 106. In other embodiments in accordance with the invention, channelized test circuit 122 may be implemented as any channelized RF component or combination of channelized RF components. For example, test circuit 122 may include a channelized transmitter, receiver, spectrum analyzer, or power meter.

In an embodiment in accordance with the invention, the standards employed by cell phones define one or more channelization schemes to differentiate one or more channels used by one phone from the channel or channels used by another phone. By way of example only, Time Division Multiple Access (TDMA), Code Division Multiple Access (CDMA), or Frequency Division Multiple Access (FDMA) may be used. The same channelization schemes may be used by test component 108 to differentiate the signals transmitted and received by one phone from the signals transmitted and received by another phone. In another embodiment in accordance with the invention, test component 108 may use a customized or non-standard technique to simultaneously test multiple cell phones. For example, CW test channels may be used to calibrate the transmitter in a phone.

In one embodiment in accordance with the invention, test component 108 measures the signals transmitted simultaneously by each phone 102, 104, 106 when the channelization schemes are orthogonal. When the channelization schemes are not orthogonal, test component 108 may measure the signals alternately transmitted by each phone. For example, test component 108 may use a packet switched channel or compressed mode. In another embodiment in accordance with the invention, test component 108 may use the coding gain of the CDMA spread spectrum signal to suppress the noise contributed by the other phones.

Testing system 100 is able to concurrently perform one or more test procedures on phones 102, 104, 106. The term “concurrent” represents the ability of test component 108 to communicate with cellular phones 102, 104, 106 at or near the same time, depending on the channelization scheme used for communications. Test circuit 122 transmits one or more composite RF signals (“test component signals”) to splitter 124, which splits the composite RF signal into multiple composite RF signals. Phones 102, 104, 106 each receive a composite RF signal over cables 110, 112, and 114, respectively. Splitter 124 may also merge one or more RF signals (“cell phone signals”) transmitted by each phone 102, 104, 106 into a composite RF signal and apply the composite RF signal to test circuit 122.

Splitter 124 is a 1×N splitter in an embodiment in accordance with the invention, where N equals the number of cell phones that can be tested concurrently. Splitter 124 may be implemented, for example, as an impedance matching circuit.

In the embodiment of FIG. 1, test circuit 122 transmits and receives one or more broadcast channels that phones 102, 104, 106 use for camping and initial signaling. Each phone 102, 104, 106 is then typically assigned to a different traffic channel for functional testing. In other embodiments in accordance with the invention, cell phones 102, 104, 106 may be assigned to independent channels through other means, such as, for example, test modes built into the phones.

Compensation values are stored in memory 128. In an embodiment in accordance with the invention, each compensation value compensates for losses that occur as a signal travels over each RF connection. The compensation values may compensate, for example, for losses in signal amplitude or power that occur between RF ports 116, 118, 120 and phones 102, 104, 106, respectively.

One of several methods may be used to determine compensation values. For example, in one embodiment in accordance with the invention, to determine the losses from RF ports 116, 118, 120 to phones 102, 104, 106, respectively, test component 108 generates a signal of known power at each RF port 116, 118, 120. A user then measures the signal received at each phone 102, 104, 106 to determine the losses. The user may then enter the losses into test component 108 using, for example, a user interface.

Controller 126 translates the entered losses into compensation values and stores the compensation values in memory 128 in the embodiment of FIG. 1. Controller 126 sets the state of test circuit 122 and supplies the appropriate information to test circuit 122 for testing phones 102, 104, 106. Controller 126 also receives information from test circuit 122 that has been sent by phones 102, 104, 106.

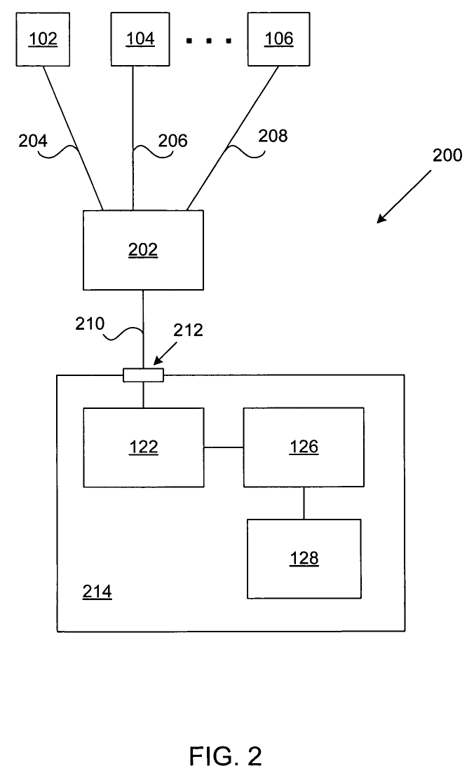

FIG. 2 is a block diagram of a second testing system in an embodiment in accordance with the invention. Testing system 200 includes cell phones 102, 104, 106 connected to splitter 202 via cables 204, 206, and 208, respectively. Phones 102, 104, 106 are typically sitting in test fixtures (not shown) during test operations, and cable 210 connects splitter 202 to test component RF port 212. Splitter 202 is a 1×N splitter in this embodiment in accordance with the invention, where N equals the number of cell phones that can be tested concurrently.

Test component 214 includes channelized test circuit 122, controller 126, and memory 128. Testing system 200 is able to perform one or more test procedures on cell phones 102, 104, 106. In one embodiment in accordance with the invention, test circuit 122 transmits one or more composite RF signals to splitter 202, which splits the composite RF signals into multiple Composite RF signals. Phones 102, 104, 106 each receive a composite RF signal over cables 204, 206, and 208, respectively. In another embodiment in accordance with the invention, test component 214 receives one or more RF signals from cell phones 102, 104, 106. Splitter 202 merges the one or more RF signals into a composite RF signal and applies the composite signal to test component 214.

Like the embodiment of FIG. 1, compensation values are stored in memory 128. In one embodiment in accordance with the invention, the compensation values compensate for losses that occur as a signal travels over each RF connection.

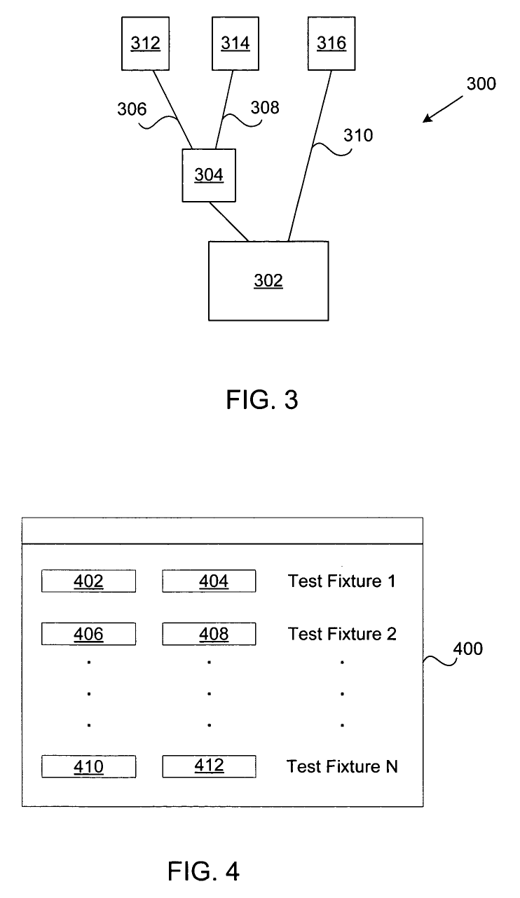

FIG. 3 is a block diagram of cascading splitters in an embodiment in accordance with the invention. Cascading splitters 300 include splitter 302 connected to splitter 304. In the embodiment of FIG. 3, splitters 302, 304 are shown as 1×2 splitters with outputs 306, 308, 310 connect to cell phones 312, 314, 316, respectively. In other embodiments in accordance with the invention, splitters 302, 304 may be configured as 1×N splitters. Moreover, cascading splitters 300 are not limited to the topology shown in FIG. 3. Cascading splitters 300 may be implemented in any desired topology.

Cascading splitters may be constructed entirely within a test component in one embodiment in accordance with the invention, and implemented entirely outside a test component in another embodiment in accordance with the invention. For example, splitter 124 in FIG. 1 and splitter 202 in FIG. 2 may be configured as cascading splitters. In yet another embodiment in accordance with the invention, a portion of the splitters in cascading splitters may reside within a test component with additional splitters located outside the test component. For example, splitter 302 may be implemented within a test component and splitter 304 employed outside the test component.

Referring now to FIG. 4, there is shown an illustration of a test component user interface in an embodiment in accordance with the invention. Interface 400 includes entry fields for each test fixture connected to a test component in one embodiment in accordance with the invention. An operator enters a loss or compensation value associated with the signals received by test fixture 1 in field 402 and the loss or compensation value for cell signals transmitted to the test component in field 404. Similarly, losses or compensation values are entered into fields 406, 408 for test fixture 2 and into fields 410, 412 for test fixture N. As discussed earlier, the losses or compensation values are then stored in memory (e.g., memory 128 in FIG. 1) in an embodiment in accordance with the invention.

1. A system for testing multiple cellular phones, comprising:
a test component including one or more channelized test circuits for testing the multiple cellular phones; and
a separate RF connection between the test component and each cellular phone, wherein one or more unique channels are assigned to each cellular phone.

2. The system of claim 1, further comprising a memory for storing one or more compensation values for each separate RF connection.

3. The system of claim 1, further comprising one or more splitters for splitting one or more test component signals output from the test component such that each cellular phone receives the one or more test component signals over a respective RF connection.

4. The system of claim 3, wherein each cellular phone transmits one or more cell phone signals to the test component over a respective RF connection.

5. The system of claim 4, wherein the one or more splitters merge the one or more cell signals transmitted from each cellular phone into a composite signal.

6. The system of claim 3, wherein all of the one or more splitters are implemented within the test component.

7. The system of claim 3, wherein all of the one or more splitters are implemented outside the test component.

8. The system of claim 3, wherein the one or more splitters comprise at least two splitters and at least one of the two or more splitters is implemented within the test component and the remaining splitters are implemented outside the test component.

9. A method for testing two or more cellular phones, comprising:
assigning to each cellular phone one or more unique channels;
transmitting a composite RF signal; and
transmitting the composite RF signal to each cellular phone.

10. The method of claim 9, further comprising selecting the one or more unique channels assigned to a respective cellular phone from the composite RF signal.

11. The method of claim 9, wherein transmitting a composite RF signal to each cellular phone comprises transmitting a composite RF signal to each cellular phone using a respective one of a plurality of RF connections.

12. The method of claim 11, further comprising determining one or more compensation values for each RF connection.

13. The method of claim 12, further comprising storing the one or more compensation values for each RF connection in a memory.

14. The method of claim 12, wherein at least one of the one or more compensation values compensates for losses in the composite RF signal transmitted over a respective RF connection.

15. A method for testing two or more cellular phones, comprising:
assigning to each cellular phone one or more unique channels;
transmitting an RF signal from each cellular phone using a respective assigned one or more unique channels;
receiving a composite RF signal comprised of the RF signals transmitted by the two or more cellular phones; and
selecting one or more RF signals from the composite RF signal.

16. The method of claim 15, further comprising determining one or more compensation values for an RF connection between each cellular phone and a test component.

17. The method of claim 16, further comprising storing the one or more compensation values for each RF connection in a memory.

18. The method of claim 15, wherein at least one of the one or more compensation values compensates for losses in a signal transmitted from a respective cellular phone over a respective RF connection to the test component.
